(19) United States
(12) Patent Application Publication
(10) Pub. No.: US 2002/0084119 A1
(43) Pub. Date: Jul. 4, 2002

(54) Motorized wheelbarrow

(76) Inventors: Florian Brabetz, Friedberg (DE); Peter Geisslinger, Schwabmanchen (DE); Gerd Klimm, Neumunster (DE)

Correspondence Address: Klaus J. Bach, 4407 Twin Oaks Drive, Murrysville, PA, 15668, US

(21) Appl. No.: 09/752,301

(22) Filed: Dec. 29, 2000

(51) Int. Cl. B60K 1/00; B60K 16/00; B60L 8/00

(52) U.S. Cl. 180/65.3; 180/908

(57) ABSTRACT

In a motorized wheelbarrow including a support frame with a wheelbarrow wheel mounted on a fork formed at one end of the frame and spars with handle portions provided at the other end of the frame and a bucket disposed on the frame the wheelbarrow wheel includes an electric hub motor for driving the wheelbarrow wheel and a containment with a battery is mounted under the bucket for supplying electric power to the hub motor under the control of a control switch mounted on one of the handles.

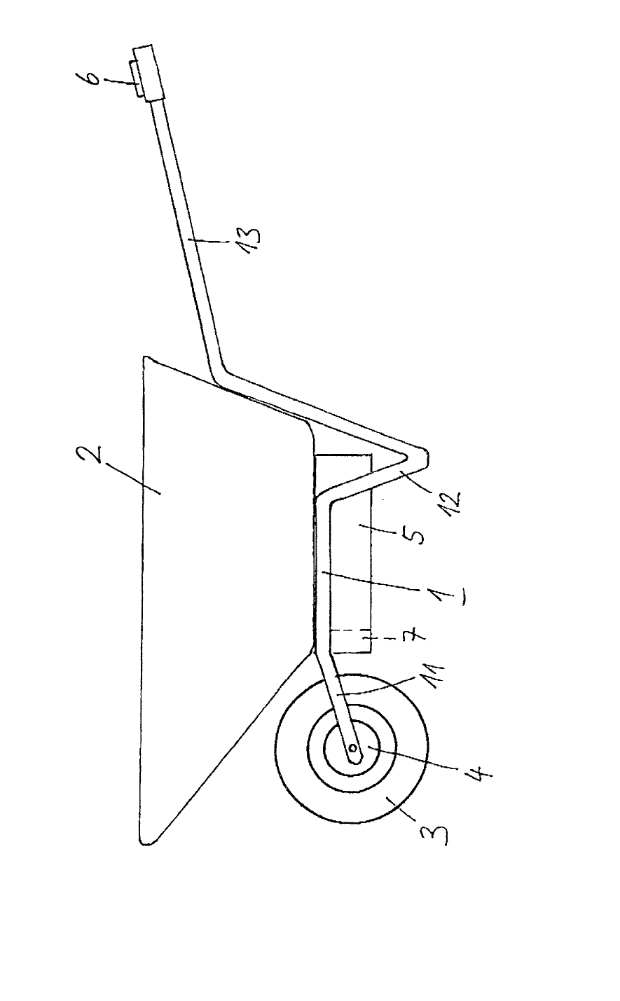

### BACKGROUND OF THE INVENTION

The invention resides in a single wheel wheelbarrow as it is used in construction and gardening and yard work. It includes a bucket for carrying materials to be moved, a support frame extending below the bucket and supporting the bucket a single wheel mounted at one end of the spars below a front part of the bucket, spars with handles disposed at the other end of the support frame and support legs disposed below the rear end of the bucket.

The transport of materials in construction areas or yards with such wheelbarrows is often difficult and cumbersome, particularly if is heavy materials have to be transported such as stones, gravel, sand and soil but also wood and compost. Often the material has to be moved on the wheelbarrow upwardly inclined ramps. In construction areas, the wheelbarrow often must be moved up on planks, which form temporary ramps. In yards, they must be moved up over embankments and slopes and over soft ground. Such tasks are cumbersome because of the efforts needed to push the wheelbarrow and because, in addition to the pushing efforts, the wheelbarrow must be kept in balance. This is often a difficult task particularly for people with relatively little experience such as hobbyists working around their home and in their yards.

Wheelbarrows with small internal combustion engines mounted under the bucket are already known. In those arrangements, the wheelbarrow wheel is driven either by a friction wheel or by way of a chain drive.

Such arrangements have disadvantages, which make their suitability questionable: A single wheel wheelbarrow is always subject to tipping over, whereby oil and gasoline may be spilled from the engine. Also, the power transmission by way of friction wheels or chain drives is vulnerable as a wheelbarrow is often used in areas where branches, leaves, paper and plastic bags and other items can be caught in the drive arrangement and cause malfunctions or even damage. Mud will render friction drives ineffective. Also the open drive arrangements may lead to accidents and injuries. It is therefore not surprising that the known arrangements have not found wide acceptance and are rarely used.

It is the object of the present invention to provide a motorized wheelbarrow which is suitable for use in the environment described earlier and whose operation is not hampered by materials entering the drive mechanism. It also should not subject the operator to accidents and injuries when using the wheelbarrow on difficult terrain.

### SUMMARY OF THE INVENTION

In a motorized wheelbarrow including a support frame with a wheelbarrow wheel mounted on a fork formed at one end of the frame and spars with handle portions arranged at the other end of the frame and a bucket disposed on the frame, the wheelbarrow wheel is provided with an electric hub motor for driving the wheelbarrow wheel and a containment with a battery is mounted under the bucket for supplying electric energy to the hub motor under the control of a control switch mounted on one of the handles.

The motorized wheelbarrow according to the invention includes an electric drive including an electric motor which is preferably disposed in the hub of the wheelbarrow and to which power is supplied from a battery, which is preferably arranged under the wheelbarrow bucket. The power is supplied to the electric motor under the control of a control device, which is arranged at the handle end of the wheelbarrow bucket support frame. The electric hub motor drives the wheel by way of its hub from the interior thereof that is part of the wheel hub is formed as the rotor of the electric motor or is directly connected to the electric motor. Such hub motors are known in the art. They are fully enclosed so that no person can be injured by reaching into the wheel drive and no materials present in construction areas or in yards can become entangled in the drive. There is furthermore no possibility of spilling fuel or engine oil so that there is no danger of contaminating the soil when the wheelbarrow tips over. Furthermore, an operator cannot be burned by any hot engine parts or mufflers as it can easily happen with internal combustion engines. Also, the arrangement is relatively light-weight; it is free of noises and exhaust gases and, with the use of batteries which are rechargeable by plugging into an electric power supply it provides for high availability and superb reliability.

An embodiment of the invention will be described below on the basis of the accompanying schematic drawings.

### BRIEF DESCRIPTION OF THE DRAWINGS

The sole FIGURE shows a wheelbarrow according to the invention.

### DESCRIPTION OF A PREFERRED EMBODIMENT

A wheelbarrow as shown in the figure includes a frame 1, a bucket 2 and a wheel 3. At its front end, the frame 1 is provided with a wheel fork 11 on which the wheel 3 is mounted. At the rear end of the bucket, the frame includes legs 12 for supporting the wheelbarrow. Spars 13 with handle portions extend rearwardly from the legs 12. The bucket 2 may consist of sheet metal or of a plastic material.

The wheel 2 includes an electric hub motor 4. It may be disposed within the hub or adjacent the hub. The housing, that is the armature of the motor, is connected to the wheel fork 11 at least so as to provide for a torque support. The rotor of the motor is connected to the wheel or is part of the wheel.

A battery containment is preferably mounted to the underside of the wheelbarrow bucket. It is adapted to receive a battery for supplying electric power to the hub motor. The battery is preferably in the form of a flat battery block, which is relatively wide but has only a small height. Preferably, the battery is disposed in the battery containment 5 so as to be easily exchangeable and provided with a plug-in structure. The battery containment is preferably provided with a charger plug-in connection.

On one of the spars 13, a control switch 6 is mounted, which can be operated by a hand. The control switch 6 is connected to the battery containment 15 by way of a control cable which is not shown. The containment may also include a control circuit, which is connected to the hub motor 4 by a power supply cable.

An electronic control unit 7 may be mounted in or on the battery containment and the charger plug in connection may be connected to the control unit, which controls the charging of the battery in the battery containment. Also, when the hub motor 4 is driven, the hub motor is switched by the control unit to act as a generator and the electric energy generated thereby is used automatically for recharging the battery. In that case, the hub motor acts as a brake whereby downhill movement of the wheelbarrow is much facilitated for the operator. A resistor may be provided for increasing the braking forces that can be generated by the motor. The arrangement may be such that braking action is automatically initiated when, with the motor in a driven state, a predetermined threshold speed value or a certain electric energy generating value is exceeded. It is also possible to provide on the control switch 6 an operating element for switching on the brake so that the operator can initiate braking operation at will.

What is claimed is:

1. A motorized wheelbarrow comprising: a support frame forming at one end a wheel fork and having at the other end spars with support handles, a bucket mounted on said frame, a wheelbarrow wheel mounted to said wheel fork for supporting said wheelbarrow, said wheelbarrow wheel including an electric hub motor for driving said wheelbarrow wheel, a battery containment receiving a battery mounted on said frame or said bucket for supplying electric power to said motor, and a control switch mounted on said support handles for controlling the electric power supply from said battery to said electric hub motor.

2. A motorized wheelbarrow as claimed in claim 1, wherein said battery containment is mounted below said bucket.

3. A motorized wheelbarrow as claimed in claim 1, wherein said battery is removably disposed in said battery containment and a plug-in structure is provided in said containment for electrical connection with said battery.

4. A motorized wheelbarrow as claimed in claim 2, wherein said battery containment is wide and of low height so as to fit below said bucket in said frame and said battery is of correspondingly low height and large width so as to fit into said containment.

5. A motorized wheelbarrow as claimed in claim 1, wherein a control unit is attached to said containment and a plug-in charger cable is connected to said control unit for plugging into a power net for charging the battery.

6. A motorized wheelbarrow as claimed in claim 5, wherein said electric motor is of the type convertible into a generator and said control unit includes electric circuitry switching said hub motor to act as a generator when said wheelbarrow wheel is driven for generating electricity which is fed back into said battery.

7. A motorized wheelbarrow as claimed in claim 6, wherein said electric circuitry includes a brake feature which can be activated by a control element mounted on said control switch on said handle.

8. A motorized wheelbarrow as claimed in claim 6, wherein said electric circuitry includes means which, with the hub motor driven by the wheel, initiates automatically electrical braking of the wheelbarrow wheel when the electricity generated by said electric motor/generator exceed a predetermined or adjustable threshold value.
